(19) United States
(12) Patent Application Publication
(10) Pub. No.: US 2024/0260514 A1
(43) Pub. Date: Aug. 8, 2024

(54) MOUNTING PANEL FOR A VERTICAL GARDEN, VERTICAL GARDEN SYSTEM WITH FOLDABLE PANELS, AND MOUNTING AND DISMOUNTING METHODS THEREOF

(71) Applicant: FERNANDO ORTIZ MONASTERIO GARZA, Mexico City (MX)

(72) Inventor: FERNANDO ORTIZ MONASTERIO GARZA, Mexico City (MX)

(21) Appl. No.: 18/426,858

(22) Filed: Jan. 30, 2024

Related U.S. Application Data
(60) Provisional application No. 63/482,855, filed on Feb. 2, 2023.

(51) Int. Cl. A01G 9/02

(52) U.S. Cl. CPC A01G 9/025

(57) ABSTRACT

Disclosed are vertical garden systems for growing and developing plants on substantially vertical or inclined wall segments, wherein said garden systems comprise a plurality of mounting panels that can be mounted, dismounted, opened and closed independently of each other, so that it is possible to generate inspection areas of the wall segment without the need to dismount the mounting panels. Such vertical garden systems can be easily installed without substantially damaging the wall segment. An irrigation system and a monitoring system for the vertical garden system with high efficiency in water consumption and low operating and maintenance costs are also envisaged. Methods of mounting and dismounting the mounting panels in the vertical garden system are also disclosed.

### FIELD OF THE INVENTION

The present invention relates, in general, to garden systems for growing and development of plants on essentially vertical or inclined wall segments, wherein said garden systems comprise a plurality of mounting panels, wherein said mounting panels are foldable independently of each other, so that they make it possible to generate one or more inspection areas of the wall segment in which said garden systems are mounted.

The invention also relates to a mounting panel for a vertical garden that comprises at least one mechanism for mounting and dismounting to a wall segment and a plurality of pixels or bags with plants or seedlings previously placed on the mounting panel, wherein the mounting and dismounting mechanism allows a selective opening of the panel mounted on the wall segment.

The invention further relates to methods of mounting and dismounting a plurality of mounting panels so as to form a vertical garden system on a wall segment.

The invention further relates to an irrigation system of the vertical garden system, which can be monitored and controlled remotely by a monitoring system so as to ensure greater quality and efficiency of the vertical garden system.

### BACKGROUND OF THE INVENTION

Vertical gardens, also known as green walls or living walls, have been known for some time, and have been characterized by combining artistic, architectural, and even environmental aspects.

In recent times, the popularization of vertical gardens is attributed to the French botanist and researcher Patrick Blanc, who developed a hydroponic system at the end of the 20th century for growing plants on vertical surfaces. His designs integrated architectural structures with integrated plants, thus creating visually impressive and, at the same time, environmentally friendly installations.

A vertical garden system is known, for example, from U.S. Pat. No. 9,226,457 B2 to Laurence et al. Such document describes, in general, a module for growing plants that is installed on a vertical wall, wherein the module includes a body for housing a growing medium for plants. Additionally, a drainage channel is installed to collect excess water that is provided to the module and that the plant is not able to retain, so that said excess water can be stored and/or recirculated in the system later through an irrigation system.

In all known vertical garden systems, including the aforementioned, there is the problem that, despite the surplus water collection systems and irrigation systems, it is inevitable that excess humidity is generated in the back of the modules that face the wall on which they are installed. Worse still, in known vertical garden systems, it is not possible to inspect the wall without having to remove the modules comprising it, so, when maintenance has not been carried out in a certain time, it is possible that the wall has substantial damage and irreparable caused by excess humidity, mold and even the formation of saltpeter. In fact, in all vertical garden systems known to date, damage due to excess humidity and the formation of mold and/or salt on the wall that supports the plant growing modules is a common problem.

In addition to the above, despite the use of irrigation systems in vertical gardens, it is common to have problems of insufficient or excess irrigation, which leads to low efficiency in plant development and a high cost to hold them in a more or less profitable manner.

Another typical problem with known vertical gardens is that their installation may cause irreversible damage to the wall segment on which they are installed, or may even require costly architectural and structural modifications which, over time, may require expensive repairs in the event that it may be necessary to permanently remove the vertical garden system.

Furthermore, in known vertical garden systems it is practically infeasible to consider the possibility or need to dismount, at least temporarily, or even permanently, one or all of the modules that make up the vertical garden system.

Furthermore, known vertical garden systems involve complex installation methods which, in many cases, require important and expensive structural or architectural modifications.

Therefore, it is desirable to have a vertical garden system that allows its modules to be easily mounted and dismounted and, at the same time, allows the wall on which said system is installed to be easily inspected without having to remove its modules.

Likewise, it is desirable to have a vertical garden system with high efficiency and low cost in plant growing, water use, and maintenance.

Furthermore, it is desirable to have a vertical garden system that requires minimal modifications to the wall for installation, maintenance, and possible temporary or permanent removal.

Likewise, it is desirable to have an irrigation system for a vertical garden system that allows to take advantage of the water resource and ensure an adequate level of hydration for the plants in the vertical garden system.

### BRIEF DESCRIPTION OF THE EMBODIMENTS OF THE INVENTION

In order to resolve the drawbacks of the state of the art, certain aspects of the invention refer to a mounting panel for vertical gardens that comprises a plurality of plants or seedlings mounted on a first face, and at least one hinge mechanism that allows mounting and dismounting the panel, as well as selectively opening it to the left or right, in a substantially vertical wall segment.

Additional aspects of the invention relate to a support structure, which can be installed in a substantially fixed manner in a wall segment and which comprises a hinge mechanism designed to coincide with the hinge mechanism of the mounting panel, so that, on one hand, the support structure allows easy and quick installation in the wall segment without causing considerable damage and, on the other hand, it enables selective mounting, dismounting and opening of a plurality of mounting panels independently of each other.

According to certain aspects, a method of mounting a plurality of mounting panels on a plurality of support structures is disclosed which, in turn, are substantially fixedly installed on a wall segment, wherein the wall segment can have an inclination between 0º and up to 105º with respect to the horizontal or earth surface.

Additional aspects of the invention relate to an irrigation system for a vertical garden system comprising a plurality of hollow, rigid or flexible conduits, or a combination thereof, suitable for water distribution, and a plurality of sprinklers installed in at least one of said conduits, so as to supply water substantially uniformly to the vertical garden system. The irrigation system also comprises a water tank or reservoir, which is preferably enabled with a remote on and off control, wherein said tank or reservoir has enough capacity to supply all the plants of the vertical garden system without an external source for a certain time. Additionally, the use of a water pumping means is provided for supplying water from the tank or reservoir to the plurality of sprinklers, and at least one stop valve, which, preferably, is enabled with a remote opening and closing control. In addition, the use of at least one water collection gutter is provided, which is installed to capture excess water that can be filtered from the plants of the garden system or generated from external sources such as, for example, rain or external irrigation through drinking water supply tankers. Furthermore, the use of a filtration means appropriately installed between the collection gutter and the tank or reservoir is provided in order to eliminate or at least reduce the presence of both organic and inorganic contaminating agents.

Additional aspects of the invention relate to a remote monitoring system for monitoring and controlling the hydration status of a vertical garden system, comprising a first computer system in communication with a second computer system via a communication network, as is known in the art. Preferably, the first computer system is installed locally in the vertical garden system, while the second computer system is installed remotely. Both the first computer system and the second computer system are configured to monitor and control certain parameters of the vertical garden system such as, for example, the level of water stored in the tank or reservoir of the irrigation system, the turning on and off of the water pumping means, the opening and closing of the stop valve, the humidity level of at least one section of the vertical garden, the level of water flow supplied by the irrigation system. In this way, the remote monitoring system can implement a computer-readable medium that enables or executes a software application to monitor and control certain parameters of the vertical garden system, as well as to generate records and projections of water consumption, longevity of the plants, and cost of operation and maintenance of the vertical garden system.

These and other aspects and advantages of the present invention and the solution to the previous objectives, and even others, will be apparent to those skilled in the art from reading the following detailed description of embodiments of the invention that, together with the accompanying drawings, illustrate aspects of the invention without limitation.

### BRIEF DESCRIPTION OF THE DRAWINGS

The accompanying drawings are used to schematically illustrate exemplary non-limiting embodiments of the present invention. The above and other advantages and features of the invention will become more apparent, and the invention will be better understood, by reading the following detailed description with reference to the accompanying drawings. It should be understood that all directions, shapes, angles, dimensions, including lengths and thicknesses, distances, etc., if any, shown in these drawings are given for illustrative purposes only and are not necessarily to scale, and the invention is not limited to them. In the following drawings, like designations denote like members unless otherwise indicated, in which:

FIG. 1 shows a front view of a mounting panel for vertical gardens in accordance with certain aspects of the invention.

FIG. 2 is a rear perspective view of the mounting panel according to FIG. 1.

FIGS. 3 to 5 illustrate the mounting panel according to FIG. 2 including support structures for a foldable mounting of the panel.

FIGS. 6 to 8 illustrate the steps of a method for constructing a vertical garden panel in accordance with certain aspects of the invention.

FIGS. 9 and 10 illustrate in greater detail certain steps of mounting a mounting panel to a support structure in accordance with certain aspects of the invention.

FIGS. 11 to 15 show in greater detail certain steps of mounting a plurality of mounting panels on at least one wall segment in accordance with certain aspects of the invention.

FIG. 16 is a schematic representation of a vertical garden system in accordance with certain aspects of the invention.

FIG. 17 is a schematic representation of a remote monitoring system in accordance with certain aspects of the invention.

### DETAILED DESCRIPTION OF THE INVENTION

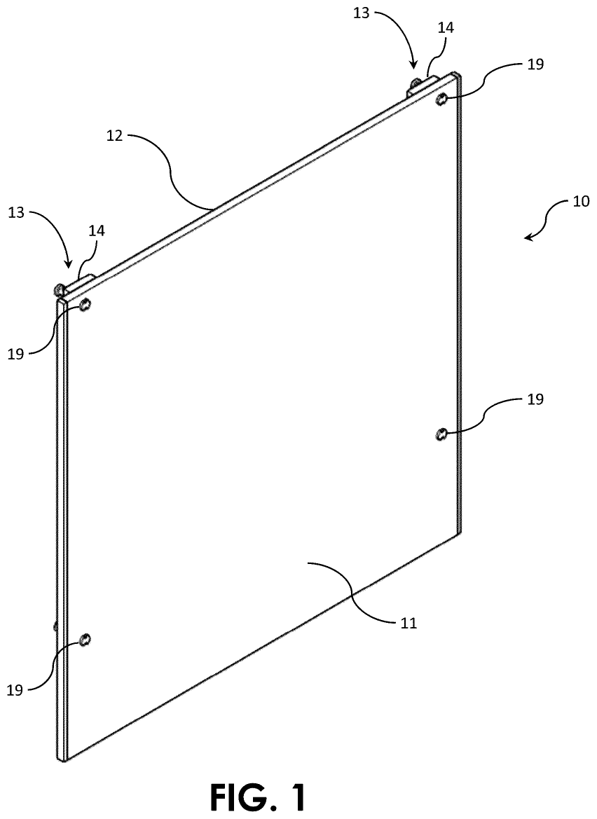

A mounting panel 10 for vertical gardens in accordance with certain aspects of the invention is shown schematically in FIG. 1. The mounting panel 10 for vertical gardens comprises a front wall 11 and a rear wall 12. The front wall 11 constitutes a first mounting face for a plurality of pre-planted bags or pixels, as will be described in greater detail below. On the other hand, the rear wall 12 constitutes a second mounting face for at least one hinge mechanism 13 which allows, on one hand, to mount and dismount the mounting panel 10 on a substantially vertical wall or surface, as will be described later, and on the other hand, open the mounting panel 10 selectively to the right or left, seen from the front, and close the mounting panel 10 again, when the mounting panel 10 is mounted on a wall substantially vertical. Preferably, the rear wall 12 comprises two hinge mechanisms 13, which can be installed and manipulated independently of each other or even simultaneously. Each hinge mechanism 13 may comprise at least one vertical bar 14 which is attached by suitable means to the rear wall 12 of the mounting panel 10, for example, by screws, rivets, bolts, adhesive, welding or a combination thereof. Furthermore, at least one winding pin or spool 19 is arranged such that it passes at least substantially through the mounting panel 10 and the vertical bar 14. Preferably, each hinge mechanism 13 comprises two winding spools 19. Optionally, each hinge mechanism 13 may comprise three or more winding spools 19.

Particularly preferably, a plurality of mounting panels 10 is provided, wherein each mounting panel 10 may have variable dimensions and shape, for example, square in shape with dimensions of 60×60 cm or 120×120 cm, or of rectangular shape with dimensions of 60 cm base×120 cm height, or 120 cm base×60 cm height. Furthermore, each mounting panel 10 may have a thickness between 10 and 20 mm.

Preferably, each mounting panel 10 is made in one piece from a plastic material, for example, polyethylene terephthalate (PET), polypropylene (PP), foamed polyvinyl chloride (PVC).

On the other hand, preferably, each of the vertical bars 14 is made of metal, for example, steel, stainless steel, aluminum or aluminum alloy.

Furthermore, the vertical bars 14 can be attached to the mounting panel 10 by suitable means, for example, by adhesive suitable for joining metals and plastics, but also by bolts, pins, screws, or a combination thereof.

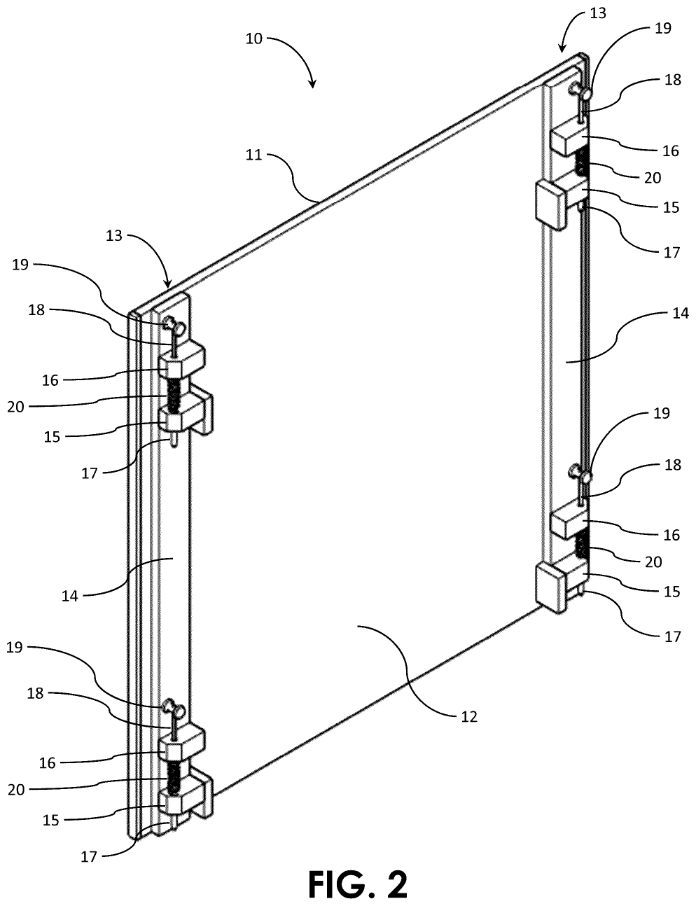

FIG. 2 is a schematic representation of the mounting panel 10 from a rear view of FIG. 1. As seen in this figure, the rear wall 12 comprises, for example, at least one, in particular two hinge mechanisms 13, each of which is installed near the vertical side edges of the mounting panel 10. Each of the vertical bars 14 comprises at least one, preferably two primary hinge elements 15, and at least one, preferably two support and guide elements 16. Furthermore, a respective fixing bolt 17 is arranged to pass at least partially through a respective primary hinge element 15 and a respective support and guide element 16 such that each fixing bolt 17 can move upwards (contracted position) and downwards (extended position) through both the respective primary hinge element 15 and the respective support and guide element 16. The fixing bolt 17 is slidable upwards by a pulling element 18, for example, a metal cable, preferably a steel cable, which in turn can be wound around the respective bolt or winding spool 19. Furthermore, each fixing bolt 17 is slidable downwards by the action of an elastic element 20, for example, a spring, as will be described in more detail below.

Particularly preferably, each of the fixing bolts 17 is designed to remain in its extended position due to the elastic element 20. Furthermore, particularly advantageously, each fixing bolt 17 can include a means for locking the same in its retracted position, the locking means of which can be activated and deactivated by the use of a tool that acts on the respective winding spool 19.

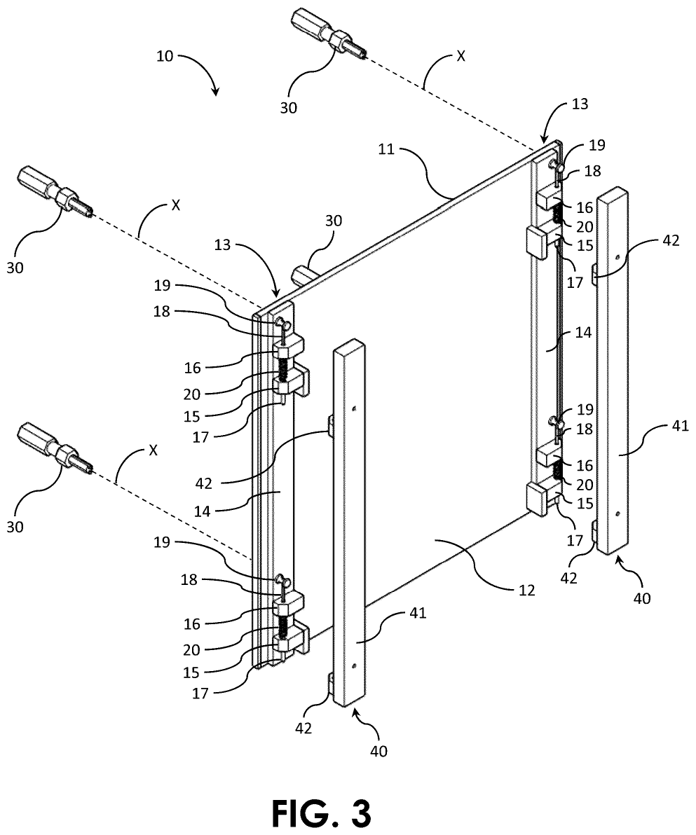

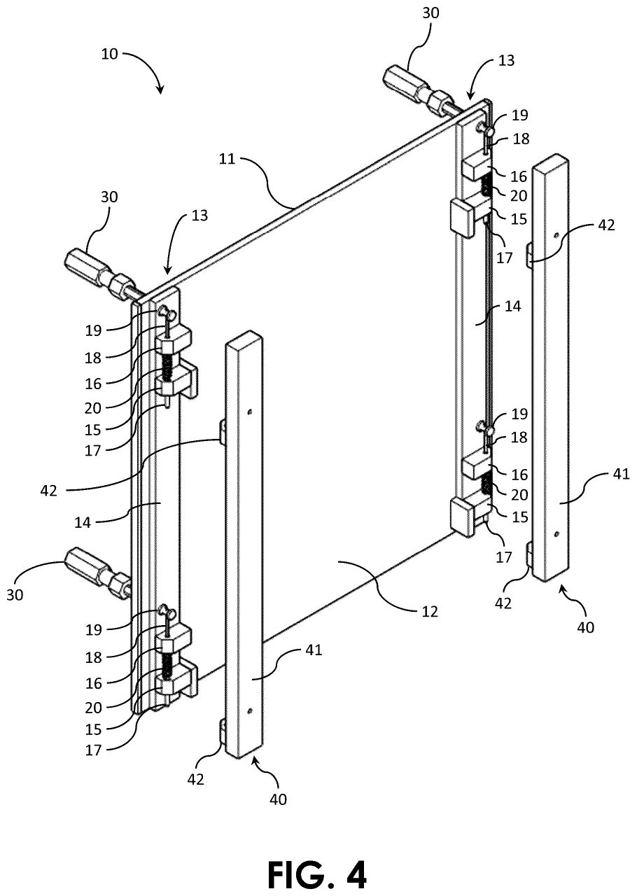

FIGS. 3, 4 and 5 are schematic representations of the mounting panel 10 according to FIG. 2 now showing, in an exemplary manner, a pair of support structures 40, also called battens, in which said mounting panel 10 can be foldably mounted. Each of the support structures 40 may in turn be mounted, for example, to a substantially vertical wall by suitable mounting means such as, without limitation, bolts, screws, pegs, hardware, etc., as will be described later. Each support structure 40 comprises at least one vertical bar 41 and at least one, preferably two secondary hinge elements 42. The mounting panel 10 can be mounted on, and detached from, the support structures 40 through the use of a tool 30, as will be described in greater detail below. In use, each of the tools 30 can be aligned with a respective head portion of each of the winding spools 19 along a respective rotation axis, such that each tool 30 can cause one rotation of each winding spool 19 in its respective longitudinal axis which, in turn, can cause a pulling or releasing effect of the respective pulling element 18, as described in greater detail below.

Preferably, each of the tools 30 has a distal portion that is designed to match with a head portion of the winding spools 19, such that the distal portion of the tools 30 allows for a form-fitting engagement with, and can therefore exert a rotational action on the head portions of the winding spools 19.

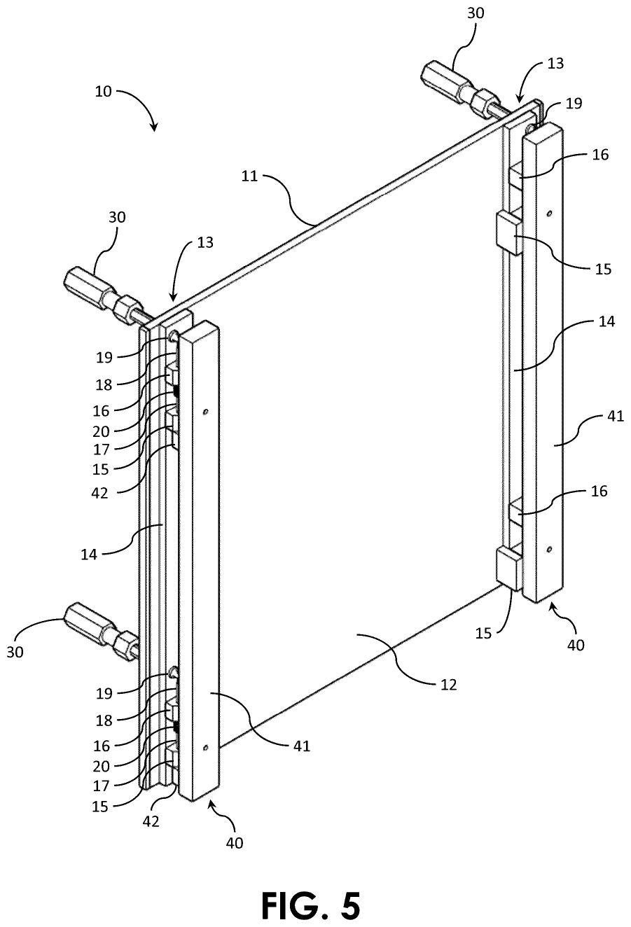

As can be seen in FIG. 5, each hinge mechanism 13 is substantially, non-permanently, fixedly mounted on a respective support structure 40. More specifically, each primary hinge element 15 rests at least partially on a respective secondary hinge element 42, and each respective fixing bolt 17 can substantially pass through the respective primary hinge element 15 and the respective secondary hinge element 42. Each set formed by a primary hinge element 15, a secondary hinge element 42 and a fixing bolt 17 forms what is generally known in the art as a hinge in which the primary hinge element 15 and the secondary hinge element 42 are rotatable relative to each other with respect to the fixing bolt 17. Nevertheless, unlike traditional hinges, the primary hinge element 15 can be separated from, i.e. no longer supported by, the respective secondary hinge element 42 by removing the fixing bolt 17 away from the secondary hinge element 42, as will be described later.

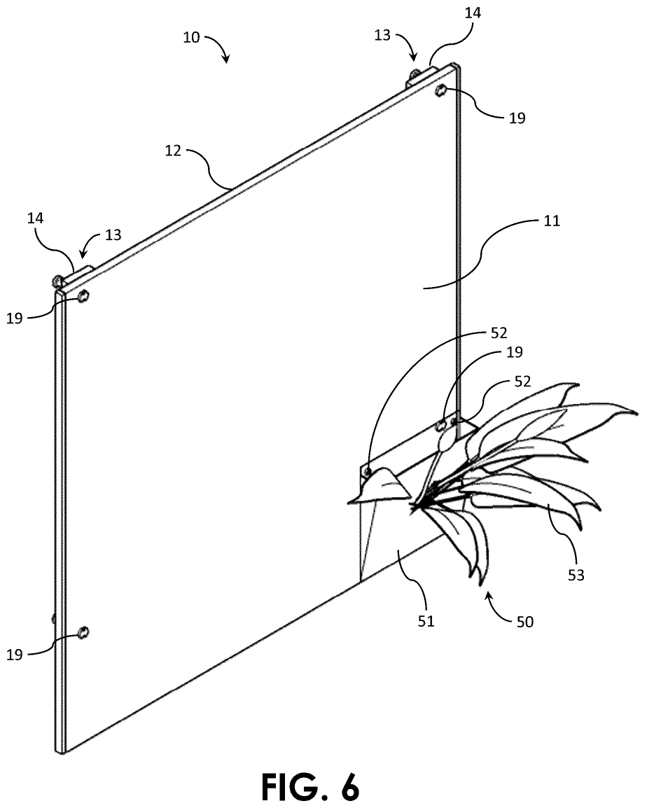

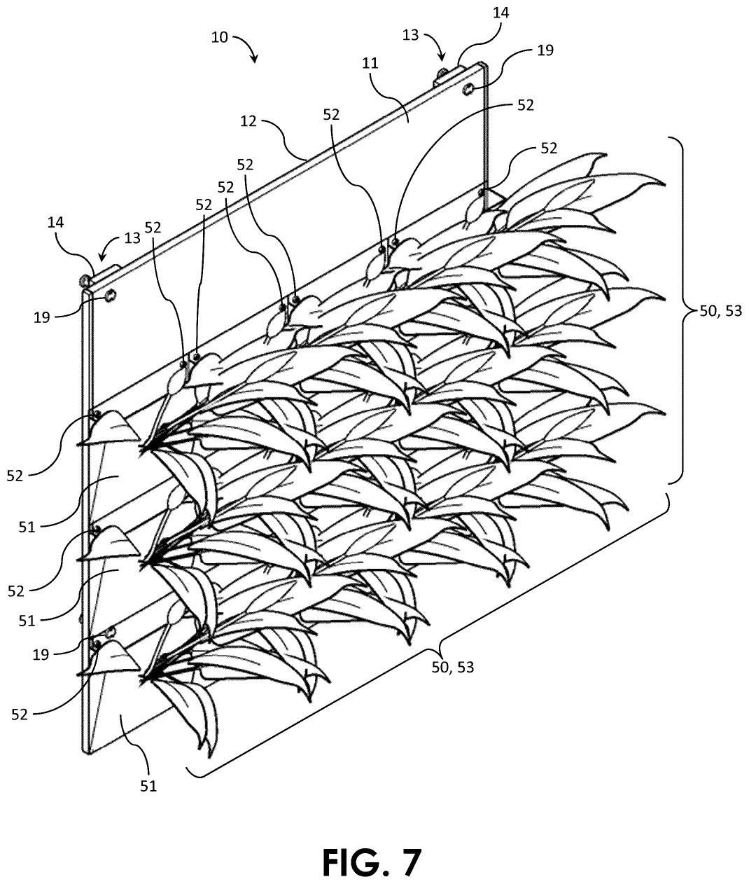

FIGS. 6 to 8 show schematic representations of the steps of a method for constructing a vertical garden panel in accordance with certain aspects of the invention. According to the invention, at least one mounting panel 10 is provided having a front wall 11 and a rear wall 12. At least two hinge mechanisms 13 are installed on the rear wall 12 of the mounting panel 10, as described above. A plurality of winding spools 19 are positioned spanning from the front wall 12 to the vertical bar 14 of the respective hinge mechanisms 13. Additionally, at least one plant and bag assembly 50, referred to herein as pre-planted pixel, is provided, each of which can be mounted in a substantially fixed manner on the front wall 11 of the mounting panel 10. Each pre-planted pixel 50 comprises at least one receptacle or bag 51 for receiving at least one plant or seedling 53 therein and a growth and development means for plants, as is known in the art. Each receptacle or bag 51 is mounted with the aid of a plurality of suitable fixing means 52, for example, by means of screws or pins, which pass through a portion of the receptacle or bag 51 and at least partially the front wall 11 of the mounting panel 10.

Preferably, the bag 51 of each pre-planted pixel 50 is configured with a substantially rectangular shape, in particular square in shape, with preferred dimensions of 15×15 cm, with a 2 cm flange on its upper portion. Additionally, each bag 51 may be manufactured from a needle-punched plastic textile material, for example, felt. To elaborate each bag 51, a preform is used to obtain pieces of such textile material in a rectangular shape with dimensions, for example, 32 cm×17 cm; said rectangular shape is folded along a longitudinal axis located at a distance of 15 cm from the long side of the rectangle, thus obtaining two squares, one with dimensions of 15×17 cm and one of 17×17 cm. Subsequently, using nylon thread, a 15 cm longitudinal seam is made one centimeter from each of the edges perpendicular to the fold previously made. Finally, the piece is turned over so that the faces that were previously inside are on the outside and vice versa, thus ensuring that the seams are hidden inside and resulting in a bag 51 with dimensions of 15×15 cm with the two centimeter tab on the top side.

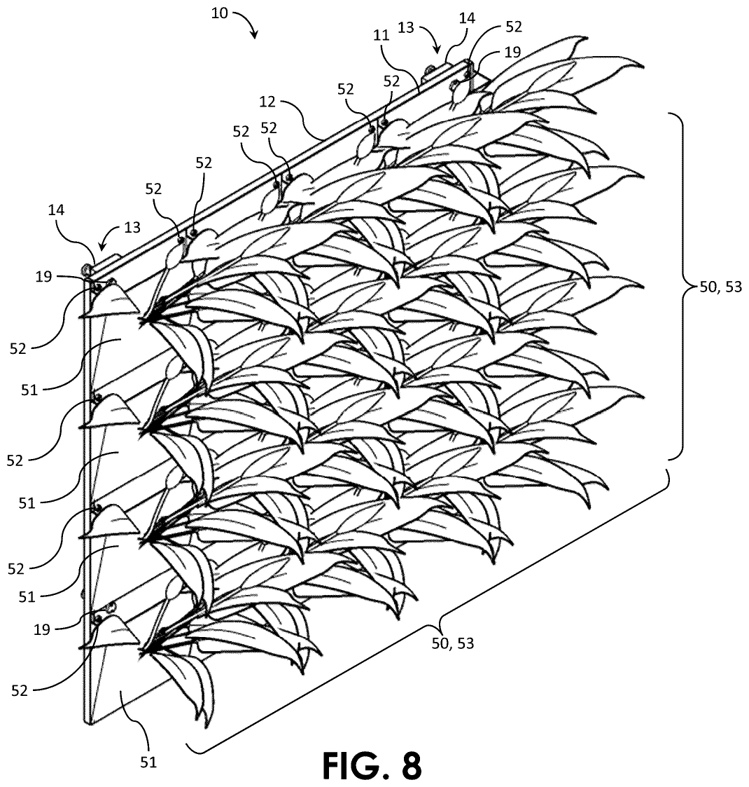

Particularly preferably, a plurality of bags 51 is mounted on the front wall 11 of the mounting panel 10 in a matrix arrangement (see in particular FIG. 8), such that the plurality of bags 51 covers at least substantially an area surface of the front wall 11 of the mounting panel 10.

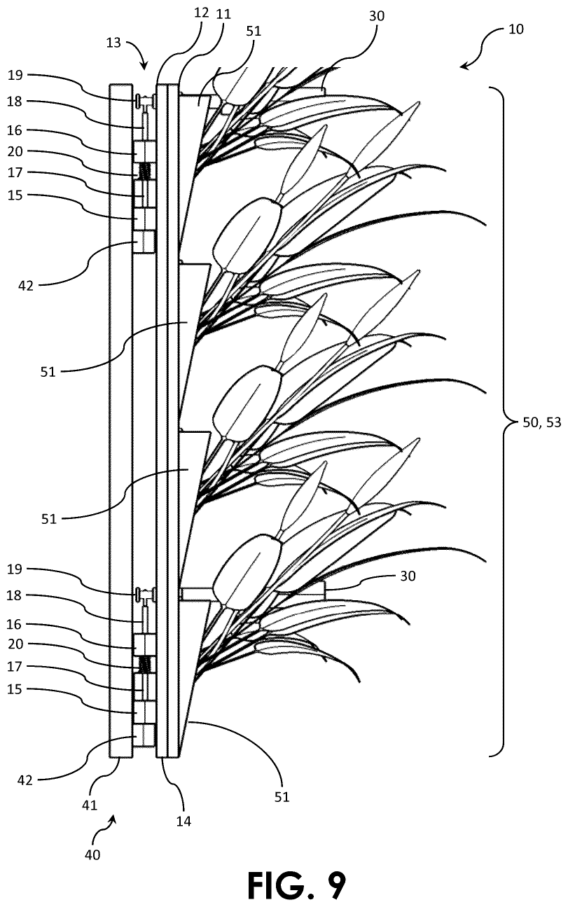

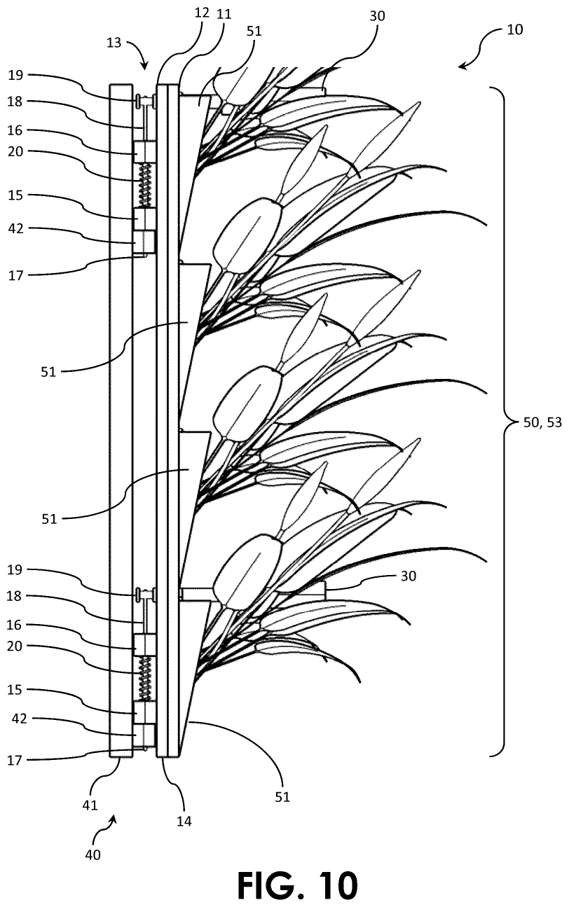

Referring now to FIGS. 9 and 10, steps regarding mounting a mounting panel 10 on a support structure 40, also referred to as a batten, are shown in greater detail in accordance with certain aspects of the invention. The mounting panel 10 comprises a plurality of pre-planted pixels 50, each with at least one bag 51 which, in turn, comprises at least one plant or seedling 53, on the front wall 11 of the mounting panel 10. At least a hinge mechanism 13 is mounted on the mounting panel 10 so that the vertical bar 14 is fixed on the rear wall 12 of the mounting panel 10. The mounting panel 10 is mounted on a support structure 40 so that each primary hinge element 15 of the hinge mechanism 13 is at least partially mounted on a respective secondary hinge element 42 of the support structure 40. This requires at least one installer or technician to manipulate a tool 30 to rotate in a first direction the winding bolt or spool 19 so that the pulling element 18 is wound on the winding bolt or spool 19 and, in turn, pulls or retracts the fixing bolt 17, simultaneously causing a contraction action on the elastic element 20, as shown in FIG. 9. Once all the fixing bolts 17 are retracted and the primary hinge elements 15 are aligned with the respective secondary hinge elements 42, the technician manipulates each tool 30 to rotate the winding bolts or spools 19 in a second direction, opposite to the first direction, so that the contraction force exerted on the elastic elements 20 can be released and the fixing bolts 17 pass substantially through the respective secondary hinge elements 42, as shown in FIG. 10. In this condition, each hinge mechanism 13 is fixedly, non-permanently mounted, on the respective support structure 40.

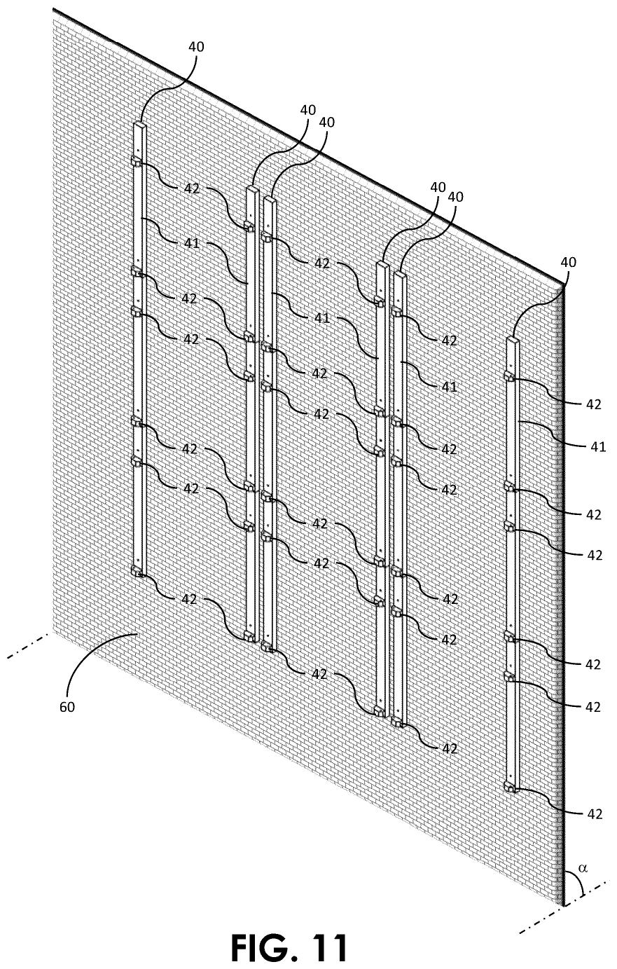

Referring now to FIGS. 11 to 15, steps regarding mounting a plurality of mounting panels 10 on at least one wall segment 60 are shown in greater detail. Particularly advantageously, the wall segment 60 can have an inclination angle α between 0° and up to 105° with respect to the horizontal or earth surface.

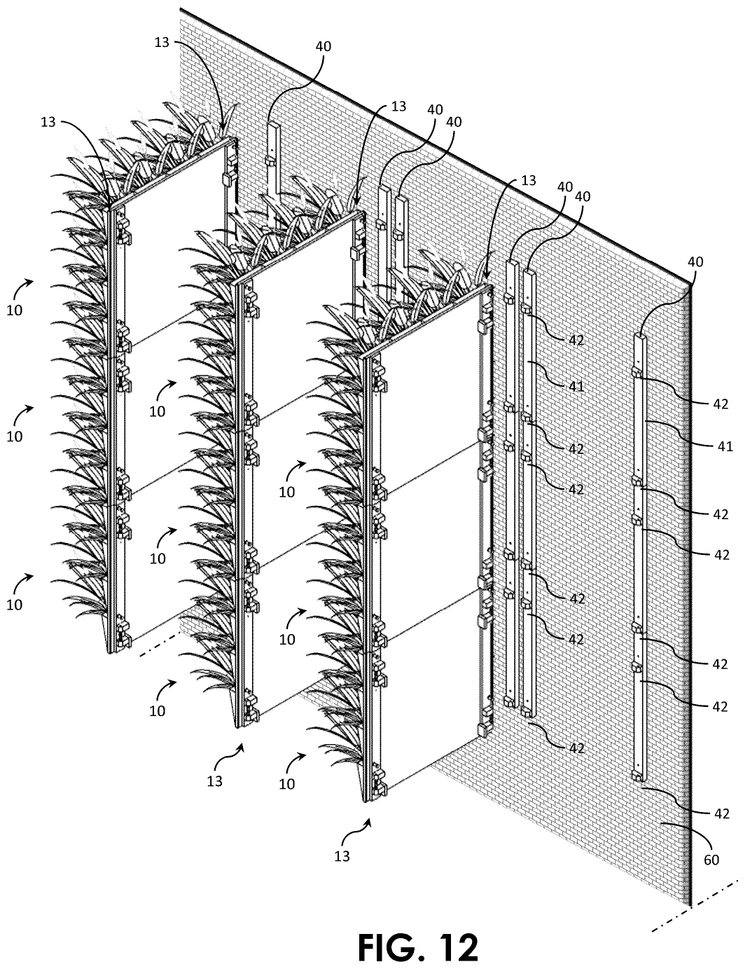

With particular reference to FIG. 11, a plurality of support structures 40 are provided, each support structure 40 comprising a vertical bar 41 which in turn comprises a plurality of secondary hinge elements 42, which are designed to match in size, dimension and spacing with respective primary hinge elements of the mounting panels, as illustrated in FIG. 12.

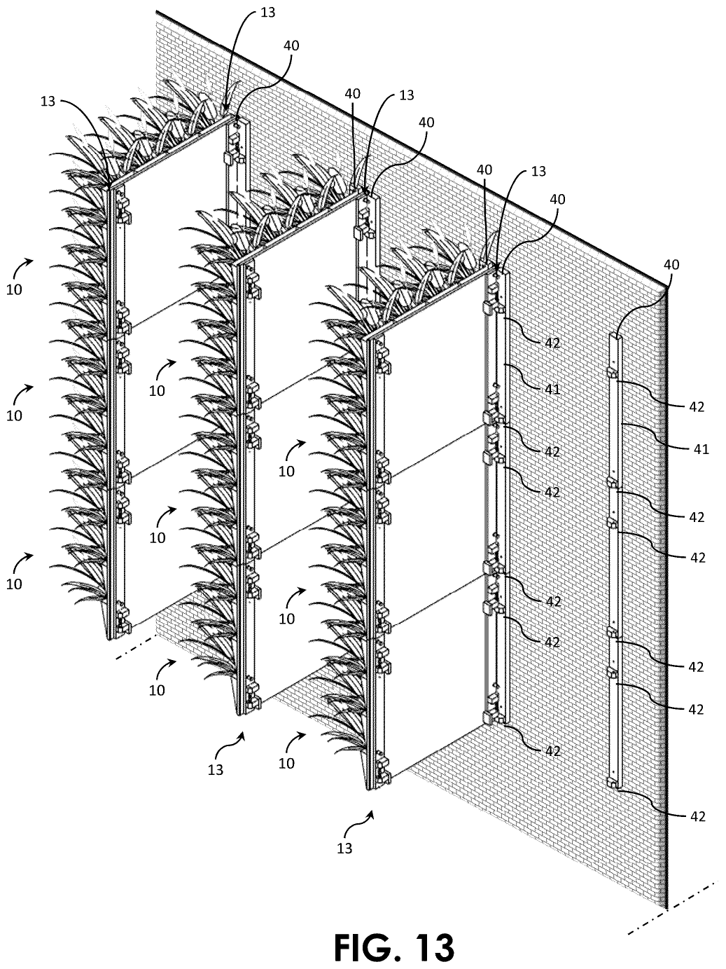

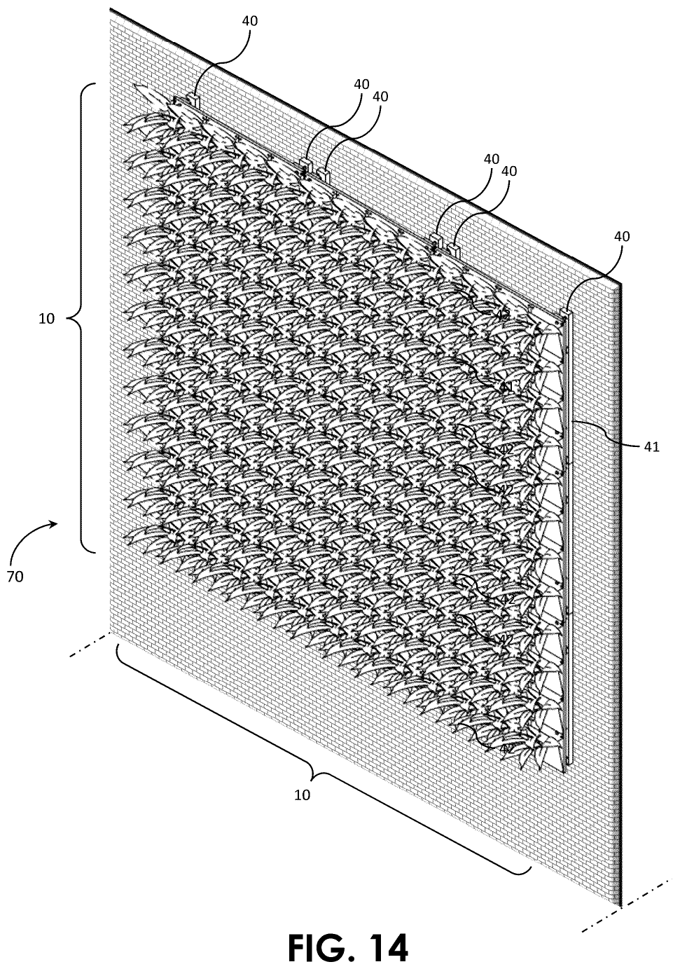

Subsequently, as illustrated in FIGS. 12 and 13, a plurality of mounting panels 10 are provided, each of which is composed as described above in relation to FIGS. 1-8. Each mounting panel 10 is aligned, either on its left or right vertical side, with the wall segment 60 so that, in particular, the primary hinge elements of the hinge mechanism 13 are aligned with respective secondary hinge elements 42 of the support structure 40. Preferably, a technician uses a tool to rotate the bolts or winding spools in a first direction so as to retract the fixing bolts (see, e.g., FIG. 9 and its related description). Once the winding pins or spools are retracted, the primary hinge elements are mounted to the secondary hinge elements 42. The technician then uses the tool to rotate the winding bolts or spools in a second direction causing the fixing bolts to extend (see, e.g., FIG. 10 and its related description). Once the fixing bolts have extended, a joint has been generated that allows the mounting panel 10 to rotate with respect to the support structure 40 in a manner similar to a door. At this time, the technician can rotate each mounting panel 10 already mounted on a support structure 40 so as to align each free or “cantilevered” hinge mechanism with a respective free mounting structure 40. Once again, the technician is required to rotate each bolt or winding spool in a first direction in order to retract the fixing bolts and, once the primary hinge elements are mounted on the respective secondary hinge elements 42, the technician rotates the bolts or winding spools in a second direction in order to cause extension of the fixing bolts through the primary and secondary hinge elements. This process is carried out on each of the mounting panels 10 such that, as illustrated in FIG. 14, the wall segment 60 comprises a vertical garden system 70 formed by a plurality of mounting panels 10.

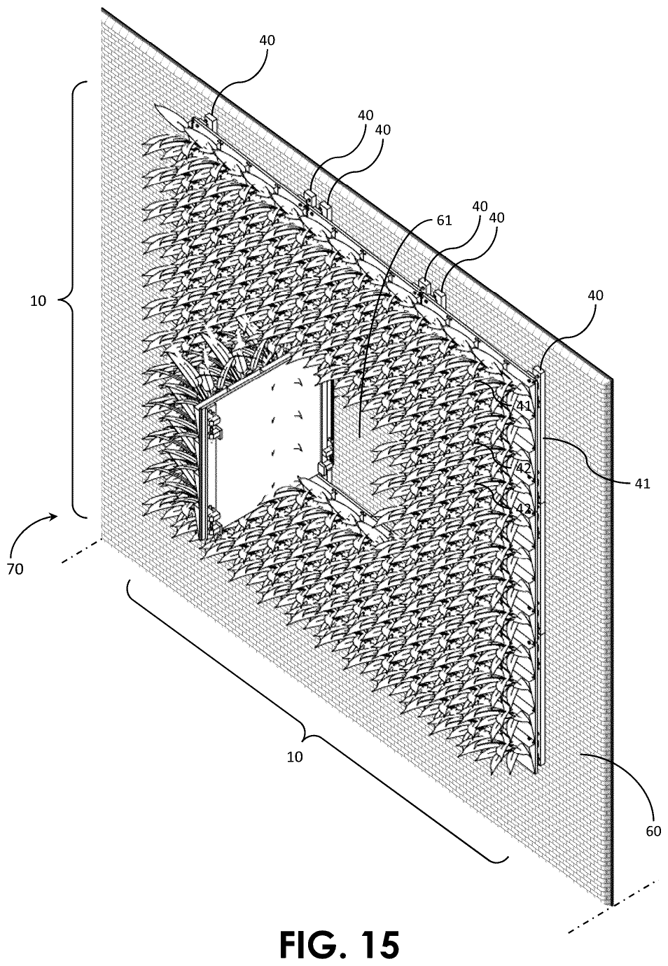

Advantageously, the vertical garden system 70 according to aspects of the invention allows a technician to “open” and “close” each of the mounting panels 10 independently of each other. For the opening process, the technician uses the tool described above to rotate the bolts or winding spools that are located on a vertical side on either the left side or the right side of the vertical mounting panel 10, which releases (retracts) the fixing bolts of the primary and secondary hinge elements, so that it is now possible to rotate the mounting panel 10, for example, to the left as in FIG. 15. In this way, with at least one open mounting panel 10 it is possible to visualize at least one inspection area 61 of the wall segment 60. After inspection, it is possible to “close” again each of the mounting panels 10 that have been opened in the same way as described above. Accordingly, the vertical garden system 70 according to the invention comprises a plurality of mounting panels 10, each of which is foldable independently of the others.

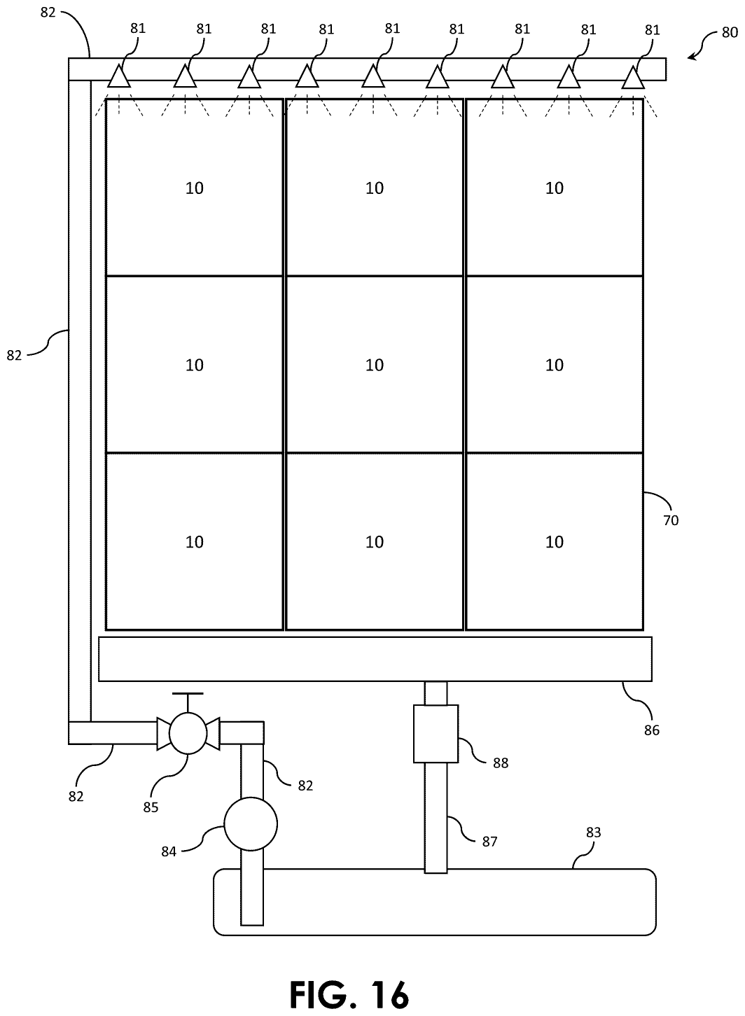

Referring now to FIG. 16, the components of an irrigation system 80 in accordance with certain aspects of the invention are schematically illustrated. The irrigation system 80 is intended to provide drinking water to a vertical garden system 70, which comprises a plurality of mounting panels 10 as described above. The irrigation system 80 comprises a plurality of rigid or flexible hollow tubes or conduits 82, or a combination thereof, suitable for water distribution, as is known in the art. In addition, a plurality of sprinklers 81 are installed in at least one of the plurality of tubes or conduits 82. The irrigation system 80 further comprises a water reservoir or tank 83, which has enough capacity to supply all the plants mounted on the plurality of mounting panels 10 for at least 5 days without the need to be replenished from an external source, and a water pumping means 84 and at least one stop valve 85, which preferably is a remote controlled solenoid valve.

The irrigation system 80 further comprises at least one water collection gutter 86, which is configured to collect, on one hand, excess water that filters downwards after dispensing water through the plurality of sprinklers 81 and, on the other hand, capture excess water that may be produced by external sources, for example, by rain or external irrigation. The water collection gutter 86 may be connected to the tank or reservoir 83 by suitable return pipe 87, as is known in the art. Additionally, at least one filtration means 88 can be installed between the water collection gutter 86 and the tank or reservoir 83 in order to eliminate or at least reduce the presence of organic or inorganic contaminating agents.

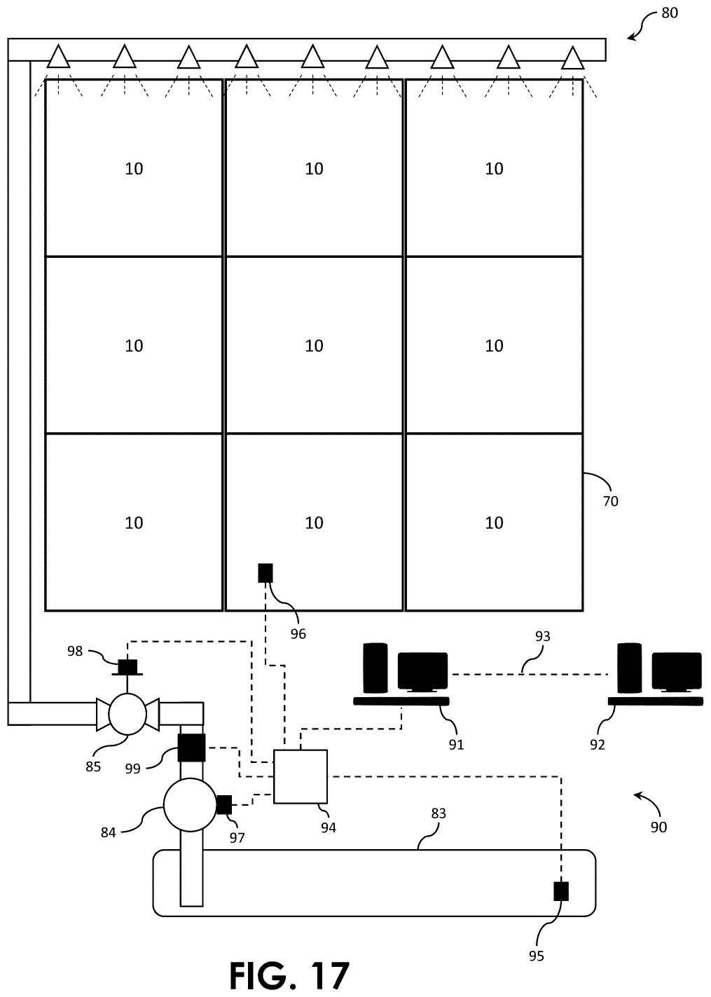

Referring now to FIG. 17, the components of a remote monitoring system 90 in accordance with certain aspects of the invention are schematically illustrated. The remote monitoring system 90 is configured to monitor and control the hydration status of the vertical garden system 70, which comprises a plurality of mounting panels 10 as described above.

The remote monitoring system 90 comprises a first computer system 91 in communication with a second computer system 92 via a wired and/or wireless network 93, as is known in the art. Preferably, the first computer system 91 is configured to locally monitor and control certain parameters in the vertical garden system 70, while the second computer system 92 is configured to remotely monitor and control said parameters.

The remote monitoring system 90 further comprises a controller 94 in communication with at least one water level sensor 95, which is suitably installed inside the tank or reservoir 83, with at least one humidity sensor 96 installed in at least one of the panels 10 of the vertical garden system 70, and with a flow sensor 99 which is suitably installed in the irrigation system 80.

Furthermore, the controller 94 is in communication with a first actuator 97 configured to remotely control the turning on and off of the pumping means 84, and with a second actuator 98 configured to remotely control the opening and closing of the stop valve 85.

Particularly advantageously, the first computer system and the second computer system are configured to execute a computer-readable medium, which in turn enables or executes a software application to monitor and control certain parameters of the vertical garden system; for example, measuring the fill level of the water tank or reservoir, measuring a humidity level of at least one section of the vertical garden system, measuring the level of water flow supplied by the irrigation system, controlling the turning on and off of the water pumping means, open and close the stop valve, as well as generate records and projections of water consumption, plant longevity, operation and maintenance cost of the vertical garden system.

The aspects described in this specification can be carried out in various ways depending on the needs. Modifications or variations to adapt the invention to meet those needs will be apparent to those skilled in the art. Such modifications or variations are intended to be included in this disclosure.

### LIST OF REFERENCE NUMERALS

10 mounting panel
11 front wall of the mounting panel 10
12 rear wall of the mounting panel 10
13 hinge mechanism
14 vertical bar
15 primary hinge element
16 support and guide element
17 fixing bolt
18 pulling element
19 bolt or winding spool
20 elastic element
30 tool
40 support structure
41 vertical bar
42 secondary hinge element
50 pre-planted pixel
51 bag
52 bag fixing means
53 plant or seedling
60 wall segment
61 inspection area
70 vertical garden system
80 irrigation system
81 sprinklers
82 hollow tubes or conduits
83 tank or reservoir
84 water pumping means
85 stop valve
86 water collection gutter
87 return pipe
88 filtration means
90 remote monitoring system
91 first computer system
92 second computer system
93 wired and/or wireless network
94 controller
95 water level sensor
96 humidity sensor
97 first actuator
98 second actuator
99 flow sensor

What is claimed is:

1. A vertical garden system (70) installed on a wall segment (60) comprising:
a plurality of foldable mounting panels (10) mounted on at least one wall segment (60), wherein each of the mounting panels (10) includes:
a front wall (11) in which at least one pre-planted pixel (50) is installed, and
a rear wall (12) in which at least one hinge mechanism (13) is installed; and
at least one support structure (40);
wherein each of the mounting panels (10) can be mounted on, and is foldable with respect to, the support structure (40).

2. The vertical garden system (70) according to claim 1, wherein each hinge mechanism (13) comprises a vertical bar (14) with at least two primary hinge elements (15) and at least two support and guide elements (16), wherein one respective fixing bolt (17) can be moved downwards to an extended position and upwards to a retracted position through a respective primary hinge element (15) and a respective support and guide element (16).

3. The vertical garden system (70) according to claim 2, wherein the fixing bolt (17) is retractable by a pulling element (18) which can be wound around a respective winding bolt (19), and the fixing bolt (17) is extendable by an elastic element (20).

4. The vertical garden system (70) according to claim 3, wherein the pulling element (18) is operable by a tool (30).

5. The vertical garden system (70) according to claim 1, wherein each support structure (40) comprises a vertical bar (41) and at least two secondary hinge elements (42), wherein the secondary hinge elements (42) are configured to correspond in shape with primary hinge elements (15) of the hinge mechanism (13).

6. The vertical garden system (70) according to claim 1, wherein each pre-planted pixel (50) comprises a bag, a fixing means (52), and at least one plant or seedling (53).

7. The vertical garden system (70) according to claim 1, wherein at least one inspection area is formed by selectively rotating left or right at least one of the mounting panels (10).

8. The vertical garden system (70) according to claim 1, further comprising an irrigation system (80) having a plurality of hollow tubes or conduits (82) and a plurality of sprinklers (81) installed in at least one of the plurality of hollow tubes or conduits (82).

9. The vertical garden system (70) according to claim 8, further comprising a tank or reservoir (83), a water pumping means (84) for supplying water through the plurality of sprinklers (81), and a stop valve (85).

10. The vertical garden system (70) according to claim 9, further comprising a water collection gutter (86) in communication with the tank or reservoir (83) for collecting excess water, and at least one filtration means (88) installed between the tank or reservoir (83) and the water collection gutter (86).

11. The vertical garden system (70) according to claim 1, further comprising a remote monitoring system that includes a first computer system (91) in communication with a second computer system (92) via a communication network (93).

12. The vertical garden system (70) according to claim 11, further comprising a controller (94) in communication with at least one of a water level sensor (95), a humidity sensor (96) and a flow sensor (99).

13. The vertical garden system (70) according to claim 11, further comprising a first actuator (97) configured to control the turning on and off of a water pumping means (84).

14. The vertical garden system (70) according to claim 11, further comprising a second actuator (98) configured to control the opening and closing of a stop valve (85).
